(19) United States
(12) Patent Application Publication
(10) Pub. No.: US 2011/0255844 A1
(43) Pub. Date: Oct. 20, 2011

(54) SYSTEM AND METHOD FOR PARSING A VIDEO SEQUENCE

(75) Inventors: Si Wu, Beijing (CN); Zhen Ren, Beijing (CN)

(73) Assignee: France Telecom, Paris (FR)

(21) Appl. No.: 12/298,979

(22) Filed: Oct. 29, 2008

(30) Foreign Application Priority Data
Oct. 29, 2007 (CN) PCT/CN2007/070975

(51) Int. Cl. G11B 27/00

(52) U.S. Cl. 386/278; 386/E05.028

(57) ABSTRACT

A system and method are provided for parsing a digital video sequence, having a series of frames, into at least one segment including frames having a same camera motion quality category, selected from a predetermined list of possible camera motion quality categories. The method includes obtaining, for each of the frames, at least three pieces of information representative of the motion in the frame. The information includes: translational motion information, representative of translational motion in the frame; rotational motion information, representative of rotational motion in the frame; and scale motion information, representative of scale motion in the frame. The method further includes processing the at least three pieces of information representative of the motion in the frame, to attribute one of the camera motion quality categories to each of the frames.

### CROSS-REFERENCE TO RELATED APPLICATIONS

This Application is a Section 371 National Stage Application of International Application No. PCT/CN2007/070795, filed Oct. 29, 2007 and published as WO ______ on ______, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The disclosure relates generally to automated video content analysis, and more particularly to a method and system for parsing a video sequence, taking account of defects or disturbances in the video frames, due to abnormal or uncontrolled motions of the camera, hereafter called “effects”.

### BACKGROUND OF THE DISCLOSURE

Video parsing is a generally used technique for temporal segmentation of video sequences. This digital video processing technique may be applied, for example, to content indexing, archiving, editing and/or post-production of either uncompressed or compressed video streams. Traditional video parsing techniques involve the segmentation of video sequences into temporal logical units such as “shots” and/or “scenes” by detecting the temporal boundaries between such scenes and shots. A shot can be defined as an unbroken sequence of frames from one camera and a scene as a collection of one or more adjoining shots that focus on an object or objects of interest.

During a camera shot, the camera might remain fixed or it might undergo one of the characteristic regular motions such as panning, zooming, tilting or tracking. Recently, with the proliferation of hand-held camera devices, such as camcorders or camera phones, which allow non professionals or non specialists to take videos for private use or “home video” applications, the problem of camera abnormal motion effects, which degrade the visual quality of the produced video, has become important. In such cases, the camera undergoes irregular motions, such as jerky motion, camera shaking, camera vibration or inconsistent motion, which results in low quality home videos.

In order to be able to enhance home video visual quality, a known pre-processing parsing technique for video archiving and editing is to provide a finer temporal shot segmentation and characterize the camera motion quality involved in the frames making up the segments, e.g. steady, panning, jerky, blurred, shaky, etc. Then, once said segments have been identified and indexed through their specific motion properties, the segments with unwanted camera motion effects might either be removed or corrected using any suitable digital video processing techniques.

Document “Video quality classification based home video segmentation”, Si Wu et al., IEEE International Conference on Multimedia and Expo, 2005, pages 217-220, which is considered the closest state of the art, proposes a segmentation algorithm for home video based on video quality classification. According to three important properties of motion, speed, direction and acceleration, the effects caused by camera motion are classified into four quality categories: blurred, shaky, inconsistent and stable using support vector machines (SVM). Then, based on the classification, a two-pass multi-scale sliding window is used to parse the video sequence into different segments along the time axis, and each of these segments is labeled as one of the camera motion effects.

However, the state of the art techniques, suffer basically from one or more of the following problems: (i) unsuitable or inaccurate classification of camera motion effects, and/or (ii) ineffectiveness of the video parsing method.

Notably, the inconsistent motion caused by uneven camera speed or acceleration may be regarded erroneously as shaky motion, because the uneven camera speed or acceleration may also be regarded as the noisy data in camera's dominant motion.

Moreover, a loss of synchronization between video and audio may occur.

### SUMMARY

A first aspect of the present invention is direct to a method for parsing a digital video sequence comprising a series of frames, into at least one segment including frames having a same camera motion quality category, selected from a predetermined list of possible camera motion quality categories, comprising the steps of:
obtaining, for each of said frames, at least three pieces of information representative of the motion in said frame, comprising:
   translational motion information, representative of translational motion in said frame;
   rotational motion information, representative of rotational motion in said frame; and
   scale motion information, representative of scale motion in said frame;
processing said at least three pieces of information representative of the motion in said frame, to attribute one of said camera motion quality categories to each of said frames.

Since the camera motion property is determined based on attributes and parameters of the camera's translational, rotational and scale motion, the camera motion can be defined more accurately to allow a better classification of the frame into one camera motion quality category.

According to one embodiment of the invention, said step of processing comprises, for a selected frame:
a) determining a camera motion property, based on said at least three pieces of information representative of the motion in said frame, in at least two temporal windows of the video sequence, each of said temporal windows including said frame;
b) based on said determined camera motion property, determining a camera motion quality category for each temporal window, with the aid of a classification process, providing a set of at least two camera motion quality categories;
c) based on said set of camera motion quality categories, assigning one of said camera motion quality categories to said selected frame, according to a decision process.

By analyzing several temporal windows for each frame the efficiency of the classification is enhanced. It should be noted that, contrarily to prior art, the processing is carried within one pass, and does not necessitate a two-pass sliding window.

According to another aspect of an embodiment of the invention, said camera motion quality categories are ordered according to a visual quality criteria, and includes a category associated to a lowest visual quality, and said decision process comprises analyzing said set of camera motion quality categories and:
in case one of said camera motion quality categories corresponds to said category associated to the lowest visual quality, assigning said category to said frame, or, in case this is not met
assigning to said frame the camera motion quality category which repeats the most, or, in case this can not be met,
assigning to said frame the camera motion quality category which corresponds to a more degraded visual quality.

According to still another embodiment of the invention, the each of the temporal windows is centered on the selected frame.

According to still another specific embodiment of the invention the step of partitioning the video sequence comprises detecting temporal segments comprising frames assigned to the same camera motion quality category.

Additionally, according to a specific embodiment, the method for digital video parsing further comprising the step of providing pieces of information representative of the start and end positions and the camera motion quality category assigned to each segment.

In another embodiment the video sequence may be a shot sequence, or the video sequence may be partitioned firstly into temporal shot segments, and said shot segments may be partitioned into further segments and classified into a certain camera motion quality.

According to another embodiment the method further comprises the step of merging at least two consecutive segments.

In still another embodiment, the step of obtaining uses affine motion models or perspective motion models to describe inter-frame camera translation, rotation and scale motion.

Said pieces of information representative of motion can take account of average speed, acceleration variance and frequency of direction change in the temporal windows.

According to another exemplary implementation, the camera motion quality categories belong to a set comprising the three categories: “blurred”, “shaky” and “stable”.

Indeed, an embodiment of the invention provides for a better efficiency than prior art, although it reduces, in this embodiment, the number of categories.

An embodiment of the invention also regards an apparatus embodying the method disclosed here-above. Such an apparatus comprises:
means for obtaining, for each of said frames, at least three pieces of information representative of the motion in said frame, comprising:
   translational motion information, representative of translational motion in said frame;
   rotational motion information, representative of rotational motion in said frame; and
   scale motion information, representative of scale motion in said frame; and
means for processing said at least three pieces of information representative of the motion in said frame, to attribute one of said camera motion quality categories to each of said frames.

A computer program product may as well implement the method for video parsing according to an embodiment of the invention.

One or more embodiment of the invention will be better understood and further advantages will become apparent from the following description of illustrative embodiments.

### BRIEF DESCRIPTION OF THE DRAWINGS

FIG. 1 represents an overview of a generally used video sequence syntax.

FIG. 2 shows a block diagram of a system for video parsing according to an embodiment of the invention.

FIG. 3 is a flow chart depicting a procedure for frame classification according to an embodiment of the invention.

FIG. 4 is a flow chart depicting a procedure for assigning a motion camera quality category to a frame according to an embodiment of the invention.

FIG. 5 illustrates an example of the resulting temporal segmentation of a given video sequence according to an embodiment of the invention.

### DETAILED DESCRIPTION OF ILLUSTRATIVE EMBODIMENTS

The video parsing method and apparatus of an embodiment of this invention are based on an efficient and easy classification technique, taking account of several types of motion (translation, rotation and scale) in each frame of a video sequence to be parsed according to the types of effects, or disturbances, affecting the frame. In the embodiment disclosed here-after, it is able to automatically parse a given video sequence just carrying out one multi-scale sliding window classification pass from the beginning to the end of the video sequence. This reduces complexity of the parsing method and system. Further, by keeping the segments classified as blurred in the parsed video sequence, the video data is kept in synchronism with the original audio, and therefore simplifying the editing operation.

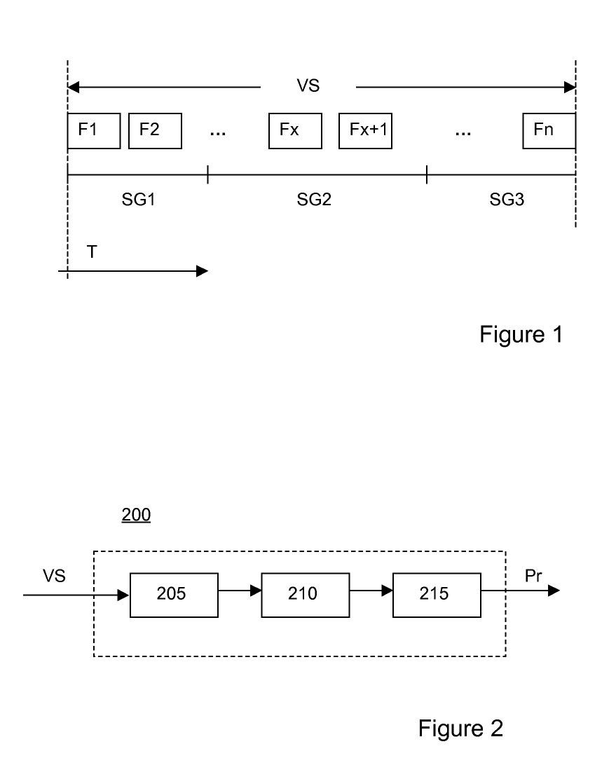

FIG. 1 illustrates a generally used structure syntax in which a video sequence VS is represented as a series of successive pictures or frames F1 to Fn along the temporal axis T. As already indicated above, a video sequence usually consists of a number of temporal logical units or segments SG1 to SG3 such as shots, each comprising a certain number of specific frames to that shot.

FIG. 2 shows a simplified block diagram of a system for video parsing 200 according to an embodiment of the invention. The system comprises a camera motion estimation module 205, a frame classification module 210 and a segment detection module 215. The camera motion estimation module 205 receives a video sequence VS and the segment detection module 215 provides parsing result information Pr.

According to an embodiment of the invention, the video sequence VS is inputted into the system and the camera motion estimation module 205 analyses the camera motion parameters on translational, rotational and scale motion in every frame, to provide, for each frame, three pieces of information representative of the motion in said frame, comprising:
translational motion information (T), representative of translational motion in said frame;
rotational motion information (R), representative of rotational motion in said frame; and
scale motion information (S), representative of scale motion in said frame.

Several mathematical models may be used to represent the camera motion between two adjacent frames, such as an affine motion model or a perspective motion model. For example, an affine motion model may be used to describe inter-frame camera's translation, rotation and scale motion. The affine motion between frame Iᵢ and its adjacent frame Iᵢ₋₁ can be denoted as:

$$[ \begin{matrix}x \\ y \\ 1\end{matrix} ] = [ \begin{matrix}{S}_{i , i - 1}^{x} & {R}_{i , i - 1}^{y} & {T}_{i , i - 1}^{x} \\ {R}_{i , i - 1}^{x} & {S}_{i , i - 1}^{y} & {T}_{i , i - 1}^{y} \\ 0 & 0 & 1\end{matrix} ] \cdot [ \begin{matrix}{x}^{′} \\ {y}^{′} \\ 1\end{matrix} ]$$

where (x, y) is the coordinate of a pixel in frame Iᵢ, and (x′, y′) is the coordinate of the corresponding pixel of (x, y) in adjacent frame Iᵢ₋₁; S_{i,i-1}^{x}, S_{i,i-1}^{y} represent scale motion; R_{i,i-1}^{x}, R_{i,i-1}^{y} represent rotation motion, and T_{i,i-1}^{x}, T_{i,i-1}^{y} represent translation motion. For example, the method disclosed by J. Konrad, F. Dufaux in “Improved global motion estimation for N3” (Meeting of ISO/IEC/SC29/WG11, No. MPEG97/M3096, San Jose, 1998) can be used to calculate the affine parameters T_{i,i-1}.

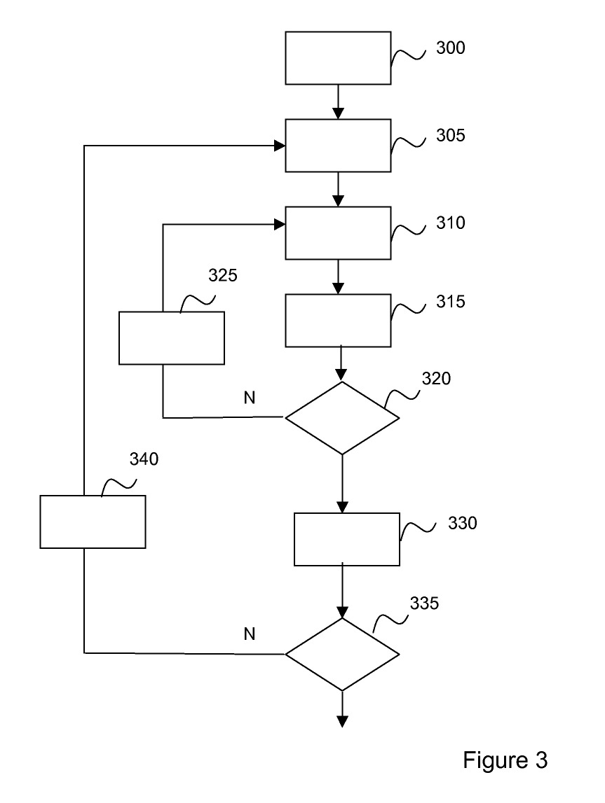

These camera motion parameters will be further used to calculate the camera motion's property as will be explained in FIG. 3.

After camera motion estimation, the frame classification module 210 is in charge to classify each frame into one camera motion quality category. The term camera motion quality category in an embodiment of this invention refers to a label indicating the visual quality effect resulting from a certain camera motion when recording a scene. As already known from the prior art, such label may be assigned to a certain video sequence segment in order to indicate to the user or a processing software the main video quality aspect or camera motion visual effect that characterizes such segment. For example, a segment may be classified as “blurred”, “shaky, “inconsistent” or “stable”. It shall be understood that other camera motion quality categories and the names given to them are possible.

Usually the set of camera motion quality categories or camera motion visual effects is predetermined and contains a certain number of categories, one of them being associated with the lowest visual quality and other being associated with the highest visual quality. According to one embodiment of the invention, each frame of the input video sequence VS is classified into one of three camera motion quality categories, said categories being “blurred', “shaky” and “stable”, the category blurred being associated to the lowest visual quality and the category stable being associated to the highest visual quality, and therefore, the visual quality degrading according to the order: stable, shaky, blurred. For example:
A) frames and segments will be assigned to a “blurred” category if the speed of camera motion is high. Due to this type of motion the captured frames will be therefore blurred. These segments may be restored by deblurring methods, such as disclosed by Li-Dong Cai, in “Objective assessment to restoration of global motion-blurred images using traveling wave equations” (Proceedings of Third International Conference on Image and Graphics, pp. 6-9, 2004);
B) frames and segments will be assigned to a “shaky” category if the speed of camera motion is normal but the direction of camera motion changes frequently, or the speed of camera motion changes inconsistently (e.g. the variance of acceleration is large). Motion caused by uneven camera speed or acceleration will be classified into this category. Shaky motions may be removed by low-pass filtering on camera's motion parameters, e.g. using methods disclosed by A. Litvin, J. Konrad and W. C. Karl in “Probabilistic video stabilization using kalman filtering and mosaicking” (Proceedings of SPIE Conference on Electronic Imaging, Image and Video Communications and Proc., Santa Clara, Calif., vol. 5022, pp. 663-674, 2003) or S. Erturk, in “Translation, rotation and scale stabilisation of image sequences” (Electronics Letters, vol. 39(17), pp. 1245-1246, 2003); or
C) frames and segments will be assigned to a “stable” category for normal camera motion property. Rare direction changes and even accelerations will also be considered as stable motion.

Once each frame has been classified into one quality category, the segment detection module 215 is in charge of partitioning the input video sequence into a number of segments, each segment comprising consecutive frames with the same assigned camera motion quality category. The camera motion quality category of each segment is determined in view of the category of its composing frames. The module may provide parsing results Pr, which comprise, for example, information about the segment boundaries, e.g. start/end position, and the camera motion quality category assigned to each segment. Said parsing results may be given to a user interface for display and/or, to a complementary system in charge of improving the visual quality of the segments having an unpleasant visual effect, e.g. blurred or shaky.

Although the exemplary embodiment shown in FIG. 1, uses the term video sequence VS as the input to the camera motion estimation module 205, it shall be understood that, generally and for the purposes of the invention, any part or temporal segment of a complete video sequence VS may be used for parsing. For example, the system for video parsing 200 according to an embodiment of the invention may receive as well video sequence shots or certain scenes of a video sequence. According to another embodiment of the invention, it is possible that the system for video parsing 200 of the embodiment of the invention receives a certain video sequence VS or video sequence segment and said video sequence or video sequence segment is previously partitioned into shots, and each (or some) of said shots is further partitioned into sub-segments classified into a certain camera motion quality category.

Referring to FIG. 3, a flow chart of a frame classification method according to an embodiment of the invention is disclosed. Said flow chart may correspond, for example to a process followed by the frame classification module 210 of FIG. 2. The exemplary frame classification method of FIG. 3 comprises the steps of initializing parameters 300, selecting a frame 305, determining camera motion property for a window centered in the selected frame 310, assigning a camera motion quality category to the window 315, checking window length iterative condition 320, increasing window length 325, assigning a motion quality category to the frame 330, checking iterative frame index condition 335 and increasing the frame index 340.

Parameters frame index I, which makes reference to a frame of the video sequence and window length J, which makes reference to an amount of frames, are initialized to a certain value in step 300. In step 305, the frame of the video sequence indicated by the value of frame index I, is selected.

In step 310, a camera motion property is determined for a video sequence temporal window, where said window w(I, J) is a segment of the video sequence comprising a certain amount of frames (defined by the window length J) and including the selected frame in step 305 (defined by the frame index I). The window may be centered on said selected frame or may be located in a different position including said selected frame.

The camera motion property may be determined according to the following description. For each given video segment, based on the camera motion estimation, camera motion property is described by statistical attributes of the camera's translational, rotational and scale motion, such as magnitude of average speed V^{x}, V^{y} on x, y axis respectively, the distribution (variance) of acceleration A^{x}, A^{y} on x, y axis respectively, and frequency of direction change D^{x}, D^{y} on x, y axis respectively.

Thanks to the use of the attributes bases on translational, rotational, and scale motion a more accurate definition of the camera motion is achieved and this reflects in a better quality category classification. For example, for the translational motion, the following statistical attributes: V^{x}(T), V^{y}(T), A^{x}(T), A^{y}(T), D^{x}(T), D^{y}(T), may be calculated, where V^{x}(T) and V^{y}(T) denote average speed, A^{x}(T) and A^{y}(T) denote acceleration variance, and D^{x}(T) and D^{y}(T) denote frequency of direction change on x and y axis respectively. The attributes for translational motion may be calculated according to the following formulas:

$${V}^{x} ( T ) = {avg}_{i} ( \vert {T}_{i , i - 1}^{x} \vert ) , {V}^{y} ( T ) = {avg}_{i} ( \vert {T}_{i , i - 1}^{y} \vert )$$

$${A}^{x} ( T ) = {var}_{i} ( \vert {T}_{i , i - 1}^{x} - {T}_{i + 1 , i}^{x} \vert ) , {A}^{y} ( T ) = {var}_{i} ( \vert {T}_{i , i - 1}^{y} - {T}_{i + 1 , i}^{y} \vert )$$

$${D}^{x} ( T ) = {avg}_{i} ( FD ( {T}_{i , i - 1}^{x} , {T}_{i + 1 , i}^{x} ) ) , {D}^{y} ( T ) = {avg}_{i} ( FD ( {T}_{i , i - 1}^{y} {T}_{i + 1 , i}^{y} ) )$$

$$FD ( {T}_{1} , {T}_{2} ) = \{ \begin{matrix}1 & if sgn [ {T}_{1} ] = sgn [ {T}_{2} ] \\ 0 & else \end{matrix}$$

and attributes V^{x}(R), V^{y}(R), A^{x}(R), A^{y}(R), D^{x}(R), D^{y}(R) for rotational motion and V^{y}(S), V^{y}(S), A^{x}(S), A^{y}(S), D^{x}(S), D^{y}(S) for scale motion may be calculated similarly as the above method.

Once the camera motion property has been determined for a certain window, a classification of said window into one of the camera motion quality categories, e.g. blurred, shaky or stable, is carried in step 315. Based on the statistical attributes of the camera rotational, translational and scale motion calculated in step 310, an automatic classification method, such as an offline statistical learning method, for example a SVM (Supported Vector Machine), can be used to provide said motion quality category for that window.

Examples of such SVMs are disclosed by C. J. C. Burges, in “A tutorial on support vector machines for pattern recognition” (Data mining and knowledge discovery, vol. 2, pp. 121-167. 1998) or J. Weston and C. Watkins, in “Multi-class support vector machines” (Tech. Rep. CSD-TR-98-04, Royal Holloway, university of London, 1998).

For example, if we suppose that three kinds of camera motion qualities are defined, and L={l₁, l₂, l₃} stands for the whole set of camera motion qualities, a one-against-all scheme may be used to train three classifiers, separately.

Given a motion effect lεL, the training sample set is:

E={(vᵢ,uᵢ)|i=1, . . . ,n}, where:
vᵢ is the feature vector that is a combination of above calculated camera motion statistical attributes, for example, vᵢ={V^{x}(T), V^{y}(T), A^{x}(T), A^{y}(T), D^{x}(T), D^{y}(T), V^{x}(R), V^{y}(R), A^{x}(R), A^{y}(R), D^{x}(R), D^{y}(R), V^{x}(S), V^{y}(S), A^{x}(S), A^{y}(S), D^{x}(S), D^{y}(S)}; and
uᵢε{+1, −1}. If vᵢ belongs to l, then uᵢ=+1, otherwise uᵢ=−1.

After the training of SVM, a decision function f can be obtained. For a given sample v, we first compute z=Φ(v), where Φ is the feature map, for example, the radial basis function can be adopted as the kernel function to implement the feature map. Then we compute the decision function f(z). If f(z)=1, then v belongs to class l, otherwise, v is not in class l.

Therefore, for a given video clip c, it is classified by:

$$F ( c ) = {l}_{i} , i = arg {{max}^{3}}_{i = 1} ( {f}_{i} ( c ) )$$

The process follows with step 320 in which the window length J is compared to a predetermined threshold value, e.g. T. If the condition is not met, for example, the value of the window length J is less or equal than the threshold value T, then the process follows with step 325 in which the window length J is increased by a certain amount or changed into another predefined larger length. Basically, the condition of step 320 defines the number of times steps 310 and 315 shall be repeated, and it is understood that a different implementation of the condition in step 320 in relation to the window length increment in step 325 is possible for achieving the same object, for example, the increment of the window length could be done before an iterative condition in step 320 is checked.

It is also understood that the increment of the window length could be implemented as a decrement if the window length J is initialized accordingly in step 300. According to an embodiment of the invention, for each frame of the input video sequence, the camera motion property is determined for at least two windows with different length containing that frame, e.g. w1 (Ix, J1) and w2 (Ix, J2), being Ix the selected frame in step 305 and which is contained in both windows w1 and w2, and J1, J2 being different window lengths.

Consequently, for each frame of the video sequence, a set of at least two camera motion quality categories is determined, one for each window. This is achieved for example, as indicated above, by way of the iterative condition in step 320 and the increment of the window length.

Therefore, by repeating steps 310 and 315 K times, K being greater than or equal to two, according to an iterative condition in step 320, for each selected frame (step 305), the process determines the camera motion property for K windows of different length and determines a set of K camera motion quality categories (one for each window centered on the selected frame to be assigned one camera motion quality category).

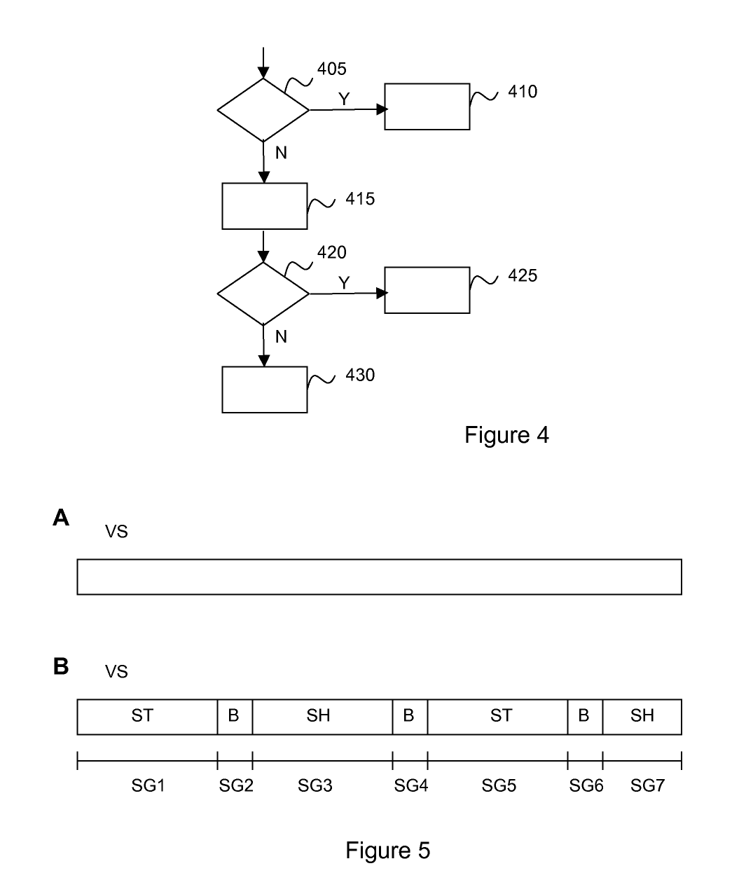

The next step in the process, step 330, is in charge of assigning to the selected frame one camera motion quality category from the previously determined set of K camera motion quality categories. This assignment can be done according to a certain decision pattern or process, and one exemplary procedure for assigning a motion camera quality category to a frame according to an embodiment of the invention is illustrated in FIG. 4.

Finally, once the selected frame of step 305 has been classified into one camera motion quality category, e.g. blurred, shaky or stable, according to assignment procedure of step 330, the condition of step 335 in connection with the step 340 provide for repetition of steps 305 to 330 for each frame of the video sequence. This can be achieved for example by setting the condition of step 335 as comparing if the currently selected frame is the last frame of the video sequence, and in case said frame is not the last one, following by the increment of the frame index I in step 340 and going back to step 305.

Therefore, according to the process described in FIG. 3, each frame of the video sequence will be assigned to a camera motion quality category. Said classification approach may be called a multi-scale sliding window classification approach.

FIG. 4 represents a procedure for assigning a motion camera quality category to a frame according to an embodiment of the invention. This procedure may be used, for example, to implement step 330 of FIG. 3. The assignment procedure may comprise the following steps: the condition in step 405 may be used to check if any of the previously determined K camera motion quality categories is the one associated with the lowest visual quality, for example in a set comprising 3 categories: blurred, shaky and stable, the condition 405 will check if any of the K determined categories is “blurred”, and in case this condition is met, that is, the set of K results contains one that is blurred, then the process classifies the frame into the blurred category in step 410. Lets say, for example that K=7 and the quality categories determined for a selected frame (corresponding to seven windows centered on that frame) are: one blurred, three shaky and three stable, and then the procedure of FIG. 4 would assign to the selected frame the category blurred.

In case the condition of step 405 is not met, that is, neither of the previously determined K camera motion quality categories is “blurred”, then the process follows with step 415 in which the categories are counted, that is, for example, all shaky and stable are counted. For example, lets say the process determined seven windows and corresponding quality categories for a frame (steps 310 and 315 of FIG. 3 repeated seven times) and the step counts three stable and four shaky.

Then the process follows with step 420 in which it is compared if the category counts is equal, that is, if the number of counted shaky is equal to the number of counted stable. In case the condition of step 420 is met, that is, the counts are not equal, for example, the number of shaky is different to the number of stable, then the process classifies the frame into the category that has the most counts in step 425. On the other hand, if the condition of step 420 is not met, that is, the number of shaky and stable is the same, the process, in step 430, assigns that frame the camera motion quality category which provides a more degraded visual quality, which in this example case would be shaky. In an implementation in which we classify the frames into three categories: blurred, shaky and stable, the visual quality of these three categories decrease according to the order: stable, shaky and blurred.

FIG. 5 illustrates an example of the resulting temporal segmentation of a given video sequence according to an embodiment of the invention. FIG. 5A shows an unlabeled video sequence VS, which can be the original video sequence received by the system 200 of FIG. 2 and which shall be parsed according to an embodiment of the invention. FIG. 5B shows the video sequence VS finally segmented and each segment classified into one camera motion quality category: stable ST, blurred B or shaky SH. According to an embodiment of the invention, for each segment, the frames of that segment have been classified into the same camera motion quality category. Said parsing information, e.g. start/end position of each segment and its classification, can be given to a user or to another system module for applying correction to the segments with unpleasant or low visual quality, e.g. shaky and blurred segments.

According to another embodiment of the invention, once the video sequence has been partitioned into segments as is shown in FIG. 5B and before providing parsing results, an additional step can be applied to the segmented video sequence for smoothing over segmentation. When a very short segment appears between two long segments, said short segment can be merged with one or two neighbouring segments.

As already indicated above, an embodiment of this invention provides an intuitive user interface for users to edit video sequences, specially recorded home video sequences, so that segments with different camera motion visual effects in the original video sequence may be identified and signaled to the user to help him determine what visual enhancement processing is to be applied to each segment or, alternatively, let a complementary system do that visual enhancement processing automatically. With the help of an embodiment of this invention, different digital video processing approaches, such as stabilization and/or deblur can be conducted on the classified segments to enhance the home video's visual quality. For example, after the video parsing, the segments classified as stable should not be improved and kept in the original video quality, and the visual quality of the other segments could be separately improved by applying low-pass filtering on camera motion parameters of shaky segments and applying deblurring methods on blurred segments. Generally, any shaky motion, such as inconsistent zooms and shaky pans, may be regarded as the noisy data in camera's dominant motion, e.g. inconsistent zooms may be regarded as the noisy data in camera's dominant scale motion, so, shaky motions may be removed by low-pass filtering on camera's motion parameters.

The video parsing method of an embodiment of this invention proposes to automatically parse a given video sequence just carrying out one multi-scale sliding window classification pass from the beginning to the end of the video sequence and keeping the segments classified as blurred in the parsed video sequence.

An embodiment of the invention could be embodied directly in a camera, in an apparatus dedicated to improvements of videos, or in a computer program to be played e.g. by a computer or a multimedia apparatus.

In view of the drawbacks of the prior art, an embodiment the present invention aims to provide an improved method, apparatus and computer program for parsing of video sequences.

Although the present disclosure has been described with reference to one or more examples, workers skilled in the art will recognize that changes may be made in form and detail without departing from the scope of the disclosure and/or the appended claims.

1. A method for parsing a digital video sequence, comprising a series of frames, into at least one segment including frames having a same camera motion quality category, selected from a predetermined list of possible camera motion quality categories, wherein the method comprises the steps of:
obtaining, for each of said frames, at least three pieces of information representative of the motion in said frame, comprising:
translational motion information, representative of translational motion in said frame;
rotational motion information, representative of rotational motion in said frame; and
scale motion information, representative of scale motion in said frame;
processing said at least three pieces of information representative of the motion in said frame, to attribute one of said camera motion quality categories to each of said frames.

2. The method for parsing a digital video sequence according to claim 1, wherein said step of processing comprises, for a selected frame:
a) determining a camera motion property, based on said at least three pieces of information representative of the motion in said frame, in at least two temporal windows of the video sequence, each of said temporal windows including said frame;
b) based on said determined camera motion property, determining a camera motion quality category for each temporal window, with the aid of a classification process, providing a set of at least two camera motion quality categories;
c) based on said set of camera motion quality categories, assigning one of said camera motion quality categories to said selected frame, according to a decision process.

3. The method for parsing according to claim 2, wherein said camera motion quality categories are ordered according to a visual quality criteria, and includes a category associated to a lowest visual quality,
and wherein said decision process comprises analyzing said set of camera motion quality categories and:
in case one of said camera motion quality categories corresponds to said category associated to the lowest visual quality, assigning said category to said frame, or, in case this is not met,
assigning to said frame the camera motion quality category which repeats the most, or, in case this can not be met,
assigning to said frame the camera motion quality category which corresponds to a more degraded visual quality.

4. The method for parsing according to claim 2, wherein each of the temporal windows is centered on the selected frame.

5. The method for parsing according to claim 1, wherein the method comprises a step of partitioning the video sequence, which comprises detecting temporal segments comprising frames assigned to a same camera motion quality category.

6. The method for parsing according to claim 1, further comprising providing pieces of information representative of start and end positions and the camera motion quality category assigned to each segment.

7. The method for digital video parsing according to claim 1, wherein the video sequence is a shot sequence.

8. The method for parsing according to claim 1, wherein the video sequence partitioned first into shot temporal segments and later, said shot segments are partitioned into further segments and classified into a certain camera motion quality.

9. The method for parsing according to claim 1, further comprising merging at least two consecutive segments.

10. The method for digital video parsing according to claim 1, wherein the step of obtaining uses affine motion models or perspective motion models to describe inter-frame camera translation, rotation and scale motion.

11. The method for parsing according to claim 1, wherein said pieces of information representative of motion take account of average speed, acceleration variance and frequency of direction change.

12. The method for parsing according to claim 1, wherein said camera motion quality categories belong to a set comprising the three categories: “blurred”, “shaky” and “stable”.

13. An apparatus for video parsing a video sequence, comprising a series of frames, into at least one segment including frames having a same camera motion quality category, selected from a predetermined list of possible camera motion quality categories, wherein the apparatus comprises:
means for obtaining, for each of said frames, at least three pieces of information representative of the motion in said frame, comprising:
translational motion information, representative of translational motion in said frame;
rotational motion information, representative of rotational motion in said frame; and
scale motion information, representative of scale motion in said frame; and
means for processing said at least three pieces of information representative of the motion in said frame, to attribute one of said camera motion quality categories to each of said frames.

14. The apparatus for video parsing of claim 13 further comprising means to record the video sequence that shall be parsed.

15. A computer program product stored on a computer readable medium and comprising program instructions for implementing a method of parsing a digital video sequence, comprising a series of frames, into at least one segment including frames having a same camera motion quality category, selected from a predetermined list of possible camera motion quality categories, when the instructions are executed by a processor, wherein the method comprises:
obtaining, for each of said frames, at least three pieces of information representative of the motion in said frame, comprising:
translational motion information, representative of translational motion in said frame;
rotational motion information, representative of rotational motion in said frame; and
scale motion information, representative of scale motion in said frame;
processing said at least three pieces of information representative of the motion in said frame, to attribute one of said camera motion quality categories to each of said frames.
